(19) United States
(12) Patent Application Publication
(10) Pub. No.: US 2016/0148557 A1
(43) Pub. Date: May 26, 2016

(54) INFORMATION PROCESSING APPARATUS AND METHOD FOR POWER SAVING

(71) Applicant: KABUSHIKI KAISHA TOSHIBA, Tokyo (JP)

(72) Inventors: Takehiro HORI, Tokyo (JP); Hisao TSUKAZAWA, Tokyo (JP)

(73) Assignee: KABUSHIKI KAISHA TOSHIBA, Tokyo (JP)

(21) Appl. No.: 14/869,056

(22) Filed: Sep. 29, 2015

Related U.S. Application Data
(60) Provisional application No. 62/084,980, filed on Nov. 26, 2014.

(51) Int. Cl. G09G 3/20; G06F 1/32

(52) U.S. Cl. CPC G09G 3/2096; G06F 1/3296; G09G 2320/0626; G09G 2330/021

(57) ABSTRACT

According to one embodiment, a processor executes a process of setting an information processing apparatus to be in a power saving state in which the internal, display is dimmed or turned off and supply of the display signal to an external display is stopped, when a time elapsed after input data is last received from an input device reaches a setting time. The elapsed time is measured by using a timer. A system controller executes a process of cyclically transmitting an event capable of clearing the timer to the processor, under a condition that the external display is connected to the external display connection terminal.

### CROSS-REFERENCE TO RELATED APPLICATIONS

This application claims the benefit of U.S. Provisional Application No. 62/084,980, filed Nov. 26, 2014, the entire contents of which are incorporated herein by reference.

### FIELD

Embodiments described herein relate generally to an information processing apparatus capable of supplying a display signal to an external display.

### BACKGROUND

Recently, various information processing apparatuses such as personal computers (PC), tablets and smartphones have been developed.

Most of the information processing apparatuses have a power saving function. For example, if the user does not operate the information processing apparatus for a certain period, the power saving function can turn off the display or set the information processing apparatus to be in a sleep state.

Electric power to be consumed by the information processing apparatus can be thereby reduced.

However, if the power saving function activates while the user executes presentation by using the information processing apparatus, a screen image may disappear though audience watch the screen image on the display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an information processing apparatus of an embodiment.

FIG. 2 is an exemplary illustration showing a relationship between the information processing apparatus of the embodiment and an external display.

FIG. 3 is an exemplary block diagram showing a structure of the information processing apparatus of the embodiment.

FIG. 4 is an exemplary diagram showing a relationship between hardware and software in the information processing apparatus of the embodiment.

FIG. 5 is an exemplary illustration showing a user interface for power saving setting used in the information processing apparatus of the embodiment.

FIG. 6 is an exemplary diagram for explanation of an operation for automatically clearing a timer of a power saving function.

FIG. 7 is an exemplary illustration showing a BIOS setup screen of the information processing apparatus of the embodiment.

FIG. 8 is an exemplary flowchart showing a procedure of an event transmission process executed by EC of the information processing apparatus of the embodiment.

FIG. 9 is an exemplary flowchart showing a procedure of another event transmission process capable of automatically varying a set time to transition to a power saving state to a certain long set time.

FIG. 10 is an exemplary flowchart showing a procedure of an operation executed by the EC of the information processing apparatus of the embodiment.

FIG. 11 is an exemplary flowchart showing a procedure of an operation executed by the BIOS of the information processing apparatus of the embodiment.

### DETAILED DESCRIPTION

Various embodiments will be described hereinafter with reference to the accompanying drawings.

In general, according to one embodiment, an information processing apparatus comprises an internal display, a display controller, a processor, and a system controller. The display controller supplies a display signal to the internal display and an external display connected to an external display connection terminal. The processor executes a process of setting the information processing apparatus to be in a power saving state in which the internal display is dimmed or turned off and the supply of the display signal to the external display is stopped, when a time elapsing after input data from the input device is last received reaches a setting time. The elapsed time is measured by using a timer. The system controller executes a process of cyclically transmitting an event capable of clearing the timer to the processor, under a condition that the external display is connected to the external display connection terminal.

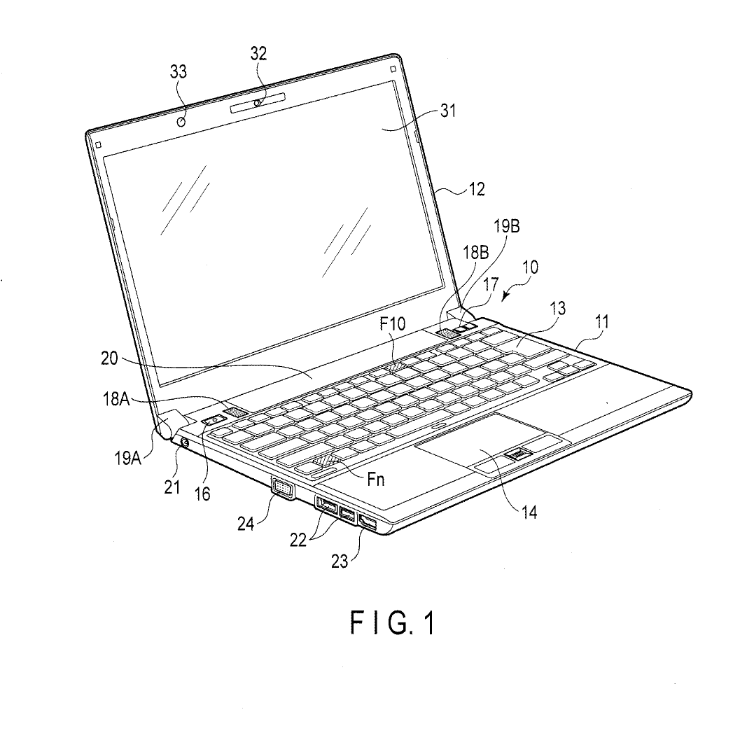

First, a structure of the information processing apparatus of one of the embodiments will be described with reference to FIG. 1. The information processing apparatus may be implemented as, for example, a notebook-type portable personal computer, a tablet terminal, or other information processing apparatuses of various types. It is hereinafter assumed that the information processing apparatus is implemented as a notebook-type portable personal computer 10.

FIG. 1 is a perspective view viewed from the front side of the computer 10 in a state in which a display unit is opened. The computer 10 is configured to receive electric power from a battery 20. The computer 10 comprises a computer main body 11 and a display unit 12. A display device such as a liquid crystal display (LCD) 31 is incorporated in the display unit 12 as the internal display. Furthermore, a camera (web camera) 32 and an illuminance sensor 33 are arranged at an upper end portion of the display unit 12. The illuminance sensor 33 is a sensor configured to detect ambient brightness.

The display unit 12 is attached to the computer main body 11 so as to be rotatable between an opened position at which the top surface of the computer main body 11 is exposed, and a closed position at which the top surface of the computer main body 11 is covered with the display unit 12. A lower end portion of the display unit 12 is coupled to a rear end portion of the computer main body 11 via rotatable hinges 19A and 19B.

The computer main body 11 comprises a housing shaped in a thin box and, on the top surface thereof, a keyboard 13, a touch pad (pointing device) 14, a power switch 16 to turn on/off the power of the computer 10, several function buttons 17, and speakers 18A and 18B are arranged.

In addition, a power connector 21 is provided at the computer main body 11. The power connector 21 is provided on the side surface or back surface, for example, the left side surface, of the computer main body 11. An external power supply is detachably connected to the power connector 21. As the external power supply, an AC adapter may be used. The AC adapter is a power supply configured to convert commercial power (AC power) into DC power.

The battery 20 is detachably mounted on a rear end portion of the computer main body 11. The battery 20 may be a battery built in the computer 10.

The computer 10 is driven by the power from the external power supply or the power from the battery 20. If the external power supply is connected to the power connector 21 of the computer 10, the computer 10 is driven by the power from the external power supply. In addition, the power from the external power supply is also used to charge the battery 20. The computer 10 is driven by the power from the battery 20 in a period in which the external power supply is not connected to the power connector 21 of the computer 10.

Furthermore, several USB ports 22, a high-definition multimedia interface (HDMI) output terminal 23, and an RGB port 24 are provided on the computer main body 11. Each of the HDMI output terminal 23 and the RGB port 24 functions as the external display connection terminal to connect the external display to the computer 10.

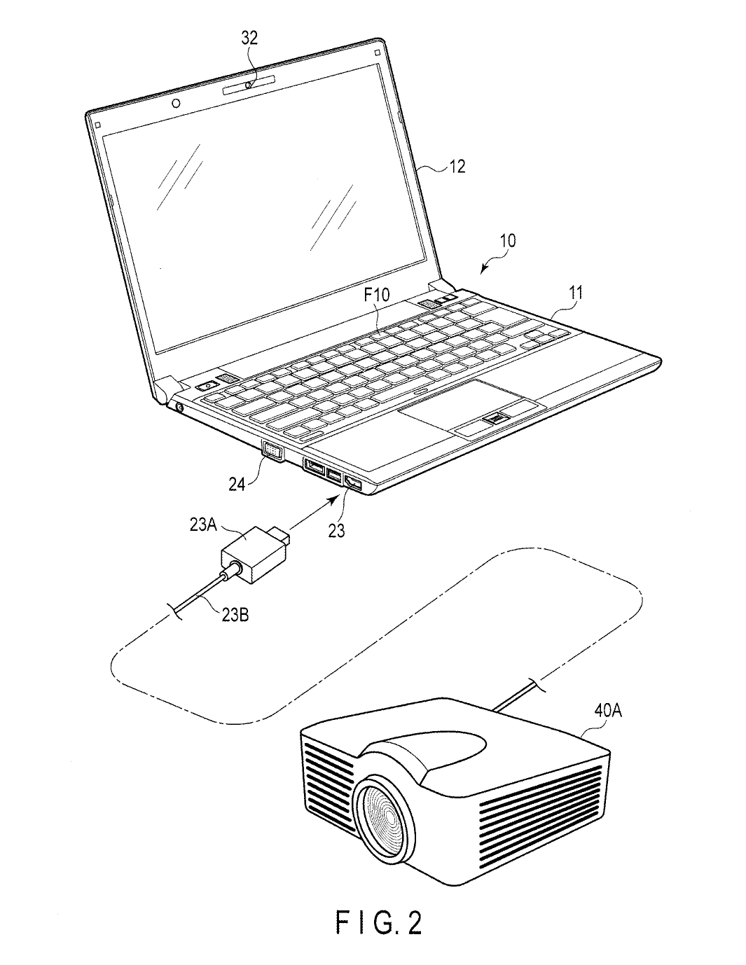

FIG. 2 shows a relationship between the computer 10 and the external display.

For example, the external display is connected to the computer 10 as needed for implementation of a multi-monitor environment or for presentation. In the presentation, a projector is often connected to the computer 10 as the external display.

In FIG. 2, connection of a projector 40A to the HDMI output terminal 23 is illustrated. The projector 40A is connected to the HDMI output terminal 23 via an HDMI cable 23B comprising an HDMI plug 23A. Alternatively, the projector 40A may be connected to the RGB port 24.

Alternatively, in the presentation, another external display such as a large-screen TV may be connected to the HDMI output terminal 23 or the RGB port 24, instead of the projector 40A.

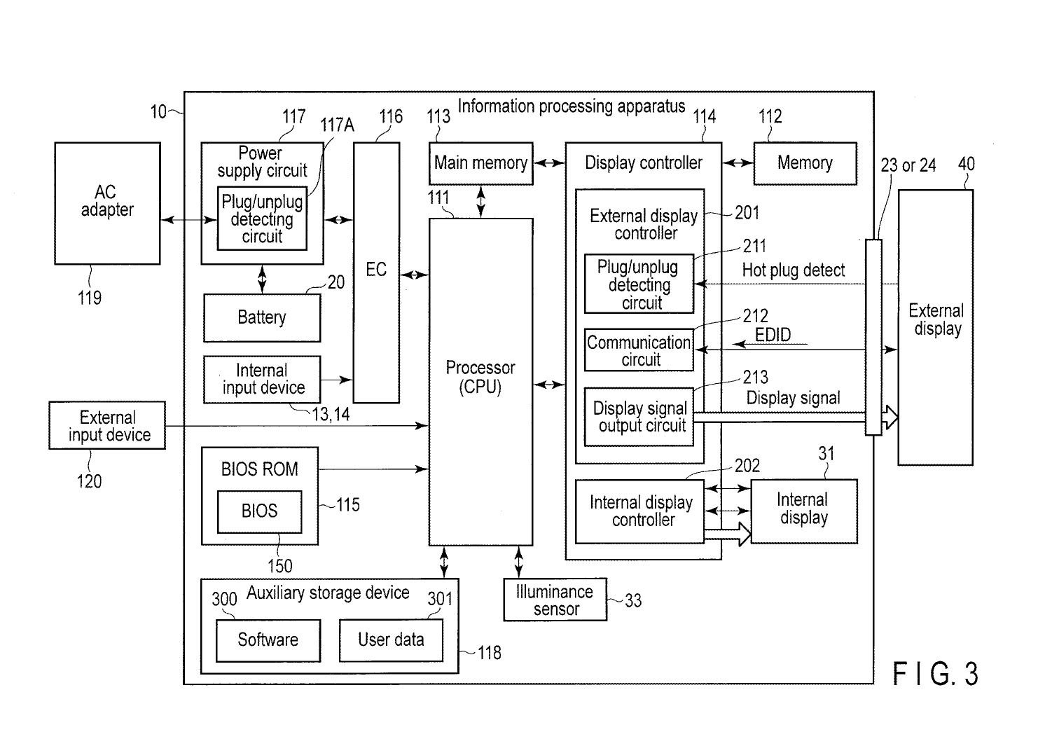

FIG. 3 shows a structure of the computer 10.

The computer 10 comprises a processor 111, a main memory 113, a display controller 114, a BIOS-ROM 115, an embedded controller (EC) 116, a power supply circuit 117, an auxiliary storage device 118, etc.

The processor 111 is a CPU configured to control operations of various components of the computer 10. The processor 111 includes circuitry (processing circuitry). The processor 111 loads software 300 and user data 301 from the auxiliary storage device 118 such as an HDD or SDD on the main memory 113. Then, the processor 111 executes the software 300. The software 300 includes an operating system (OS) and various application programs.

The processor 111 also executes a Basic Input Output System (BIOS) 150 stored in the BIOS-ROM 118 which is a nonvolatile memory. The BIOS 150 is a system program for hardware control.

The display controller 114 is a display control circuit which controls the LCD 31 used as the internal display of the computer 10. The display controller 114 also controls the external display 40 connected to the external display connection terminals (HDMI output terminal 23 and RGB port 24). The display controller 114 detects each of the LCD 31 and the external display 40, and reports the detected LCD 31 and the detected external display 40 to the processor 111. The display controller 114 uses the main memory 113 or an exclusive memory 112 as a video memory (VRAM), and generates display signals which should be supplied to the respective LCD 31 and the external display 40, from display data stored in the VRAM.

A display signal format supplied to the LCD 31 may be different from a display signal format supplied to the external display 40. For example, an eDP signal and an LVDS signal may be supplied to the LCD 31 as the display signals, and an analog RGB signal or an HDMI video signal may be supplied to the external display 40 as the display signal.

The display controller 114 may comprise an external display controller 201 and an internal display controller 202.

The external display controller 201 comprises a plug/unplug detecting circuit 211, a communication circuit 212 and a display signal output circuit 213.

The plug/unplug detecting circuit 211 detects plugging the external display 40 in the external display connection terminal and unplugging the external display 40 from the external display connection terminal. Even in a period in which the computer 10 is a powered-on state, the plug/unplug detecting circuit 211 can detect plugging the external display 40 in the external display connection terminal and unplugging the external display 40 from the external display connection terminal. The plug/unplug detecting circuit 211 may detect plugging or unplugging of the external display 40 by using a hot plug detect signal from the external display 40. When the external display 40 is in an operable state, the hot plug detect signal from the external display 40 is at “1” level.

The communication circuit 212 reads identification information called EDID from the external display 40. The identification information (EDID) of the external display 40 includes an image size of the external display 40, a serial number of the external display 40, and other various device information on the external display 40.

The display signal output circuit 213 generates a display signal applicable to the external display 40 based on the identification information (EDID) of the external display 40, and supplies the display signal to the external display 40.

Similarly to the external display controller 201, the internal display controller 202 also generates a display signal for the LCD 31 based on the identification information (EDID) of the LCD 31, and supplies the display signal to the LCD 31.

The EC 116 functions as a system controller configured to execute power management of the computer 10. The EC 116 has a function of powering on and off the computer 10 in response to the user operation of the power switch 16. At power-on of the computer 10, the EC 116 controls a power-on sequence (control of timing of reset, and control of timing of the release of reset) of each component in the computer 10. The EC 116 also executes control of charging/discharging of the battery 20. The EC 116 is implemented as a processing circuitry such as a one-chip microcomputer. The EC 116 may incorporate a keyboard controller configured to control an internal input device such as the keyboard (KB) 13 or the touch pad 14. Even in a period in which the computer 10 is powered off, the EC 116 operates by the power from the battery 20 or the power from the AC adaptor 119.

The power supply circuit 117 generates electric power to drive various components of the computer 10 by using the power from the battery 20 or the power from the AC adaptor 119. The power supply circuit 117 includes an arbitrary number of DC-DC converters, voltage regulators, load switch circuits, etc. to generate the power which should be supplied to each component. The power supply circuit 117 also includes a plug/unplug detecting circuit 117A configured to detect plugging/unplugging of the AC adaptor 119.

The external input device 120 is an input device connected to the computer 10 as needed. An example of the external input device 120 comprises a keyboard, a touch pad, a click pad, an accupoint, a touch panel, a mouse, a camera, a microphone, etc.

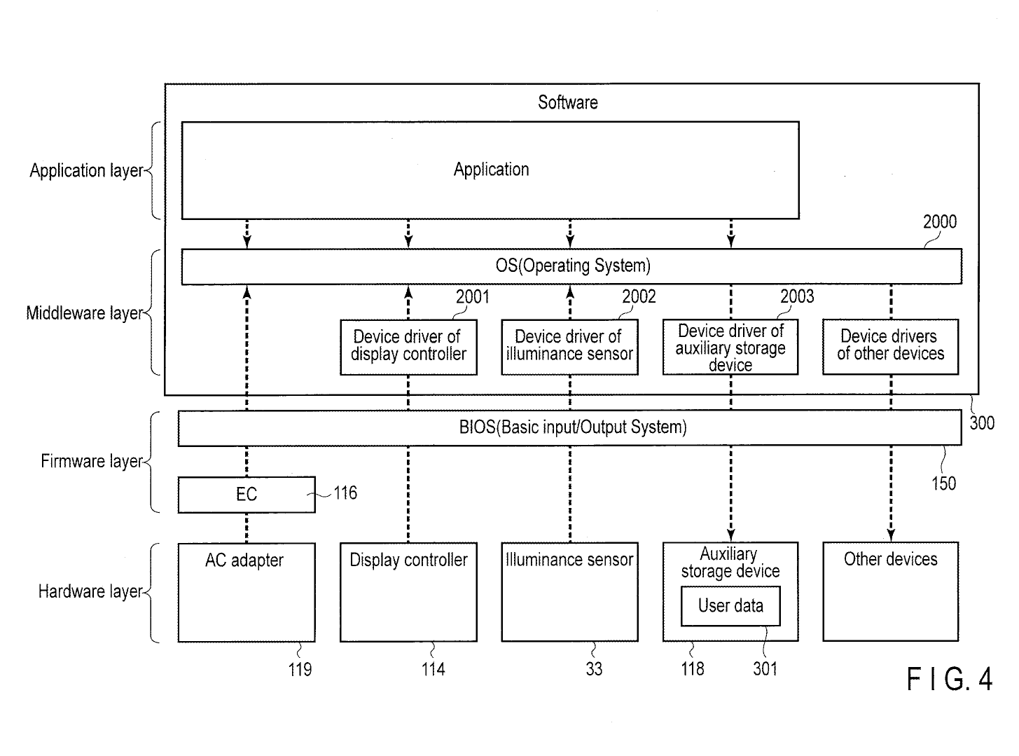

FIG. 4 shows a relationship between the hardware and the software in the computer 10.

In the computer 10, OS 2000 includes a device driver 2001 of the display controller 114, a device driver 2002 of the illuminance sensor 33, a device driver 2003 of an auxiliary storage device 118, and device drivers of the other devices. The OS 2000 reads information of each device and controls each device, via the BIOS 150, in response to function calling from each application. In addition, the OS 2000 can also receive status information regarding the AC adaptor 119 from the EC 116 via, for example, the BIOS 150.

The OS 2000 has a power saving function for reducing power consumption of the computer 10. The power saving function is mainly employed to extend the time for driving the computer 10 by electric power from the battery 20.

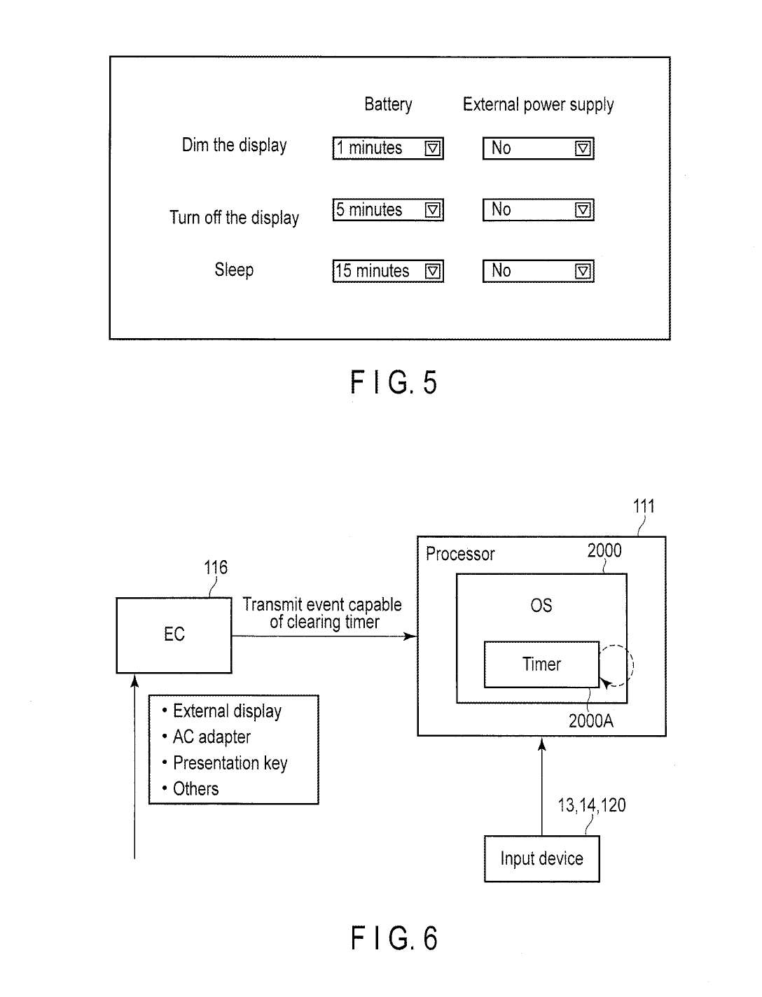

FIG. 5 shows an example of a user interface for setting for saving the power.

“Dim the display”: This setting item sets a time from the time point when reception of the input data from the input device is stopped to the time point when the display is to be dimmed. The user can set the time corresponding to this setting item, for each of the battery drive and the connection of the external power supply (AC adaptor). A minimum value of the available setting time is, for example, 1 minute. The user can also select “no” to invalidate the power saving function for dimming the display.

When the time elapsed after the reception of the input data from the input device is stopped reaches the setting time (for example, 1 minute), i.e., when the input device is continuously unoperated by the user during the setting time (for example, 1 minute), the screen of the LCD 31 is dimmed.

“Turn Off Display”: This setting item sets a time from the time point when reception of the input data from the input device is stopped to the time point when the display is turned off. The user can set the time corresponding to this setting item, for each of the battery drive and the connection of the external power supply (AC adaptor). A minimum value of the available setting time is, for example, 1 minute. The user also can select “no” to invalidate the power saving function for turning off the display.

When the time elapsed after the reception of the input data from the input device is stopped reaches the setting time (for example, 5 minutes), i.e., when the input device is continuously unoperated by the user during the setting time (for example, 5 minutes), the LCD 31 is turned off. If the external display 40 is connected to the computer 10, not only the LCD 31, but also the external display 40 are turned off. As for the LCD 31, transmission of the display signal from the display controller 114 to the LCD 31 is stopped. Furthermore, supply of the power to the LCD 31 may be stopped. As for the external display 40, transmission of the display signal from the display controller 114 to the external display 40 is stopped. The external display 40 thereby automatically enters an off (sleep) state.

“Sleep”: This setting item sets a time from the time point when reception of the input data from the input device is stopped to the time point when the computer 10 enters the sleep state (standby state or hibernation state). The user can set the time corresponding to this setting item, for each of the battery drive and the connection of the external power supply (AC adaptor). A minimum value of the available setting time is, for example, 1 minute. The user also can select “no” to invalidate the power saving function for setting the computer 10 to be in the sleep state.

When the time elapsed after the reception of the input data from the input device is stopped reaches the setting time (for example, 15 minutes), i.e., when the input device is continuously unoperated by the user during the setting time (for example, 15 minutes), the computer 10 enters the sleep state. The LCD 31 is thereby turned off. As for the external display 40, since transmission of the display signal from the display controller 114 to the external display 40 is stopped, the external display 40 automatically enters the off (sleep) state.

Thus, when the user does not operate the computer 10 for a certain period, the computer 10 becomes in a power saving state in which the LCD 31 is dimmed or is turned off and supply of the display signal to the external display 40 is stopped.

Under a condition that the user uses the external display 40 such as the projector 40A to make a presentation to audience, however, if the user continues speaking to the audience without operating the computer 10 for a certain period, a screen image projected by the projector 40A may disappear by the power saving function.

For this reason, in the present embodiment, the computer 10 has an operation mode of suppressing the computer 10 entering the power saving state by the power saving function. This operation mode is executed only when a specific condition is met. This operation is hereinafter called a presentation mode.

Several characteristics of the presentation mode will be explained below.

FIG. 6 shows an operation executed by the EC 116 in the presentation mode. In the presentation mode, the EC 116 invalidates a timer 2000A of the power saving function. The timer 2000A is used by the OS 2000 running on the processor 111 to measure a time elapsed after the input data from any one of the input devices 13, 14 and 120 is last received, i.e., a period in which the input data is not received. The timer 2000A may be a software timer or a hardware timer. The EC 116 cyclically transmits an event capable of clearing the timer to the processor 111, to suppress the computer 10 entering to the power saving state. In other words, in the presentation mode, the EC 116 cyclically transmits the event to the processor 111, irrespective of whether the input device 13, 14 or 120 is operated by the user or not.

This event is a type of dummy command simulating a user operation such as the user operation of the input device. As an example of this event, an arbitrary command or data which can clear the timer 2000A can be used. For example, a set of commands may be used as the event, the set of commands including a command to move cursor coordinates of a pointing device by one or more pixels and a command to return the cursor coordinates to the original position. The computer 10 entering the power saving state can be thereby suppressed without giving influence to an operation of a running application program.

Alternatively, a notify command to notify the OS 2000 that the device is detected may be used as the event. The notify command is one of commands defined under Advanced Configuration and Power Interface (ACPI) Standard.

The notify command may be notified to the OS 2000 via the BIOS 150. In this case, the EC 116 may cyclically transmit an interrupt signal to the processor 111 to cyclically transmit the notify command to the processor 111. When the processor 111 receives the interrupt signal, the BIOS 150 is called by the processor 111. The BIOS 150 is thereby executed, and the BIOS 150 notifies the OS 2000 of the notify command.

The EC 116 determines whether specific conditions (presentation mode start conditions) are met or not, and operates in the presentation mode only when the specific condition is met. The EC 116 may determine whether a specific condition is met or not, based on, for example, whether the external display 40 is connected to the external display connection terminal or not.

By using the condition that the external display 40 is connected to the external display connection terminal as the presentation mode start condition, the EC 116 can be prevented from operating in the presentation mode in a state in which the external display 40 is not connected In other words, the EC 116 operates in the presentation mode in an only period in which the external display 40 is connected to the external display connection terminal of the computer 10.

Alternatively, a combination of the condition that the external display 40 is connected to the external display connection terminal and at least one of conditions explained below may be used as the presentation mode start condition.

Condition: <Presentation Key is Pressed by User>

The presentation key is a key for validating the presentation mode, and is used by the user to explicitly notify the system that the presentation is started. For example, a combination of “Fn” key and “F10” key shown in FIG. 1 may be used as the presentation key. Alternatively, a dedicated key or dedicated button corresponding to the presentation key maybe arranged on the computer main body 11. The user can explicitly notify the system of the start of presentation by pressing the presentation key. The EC 116 operates in the presentation mode under the conditions that, for example, the external display 40 is connected to the external display connection terminal and that a key operation to validate the presentation mode (i.e., pressing of the presentation key) is executed. Even when the external display 40 is connected to the external display connection terminal, the EC 116 does not operate in the presentation mode if the presentation key is not pressed.

Condition: <Computer 10 is Driven by Power from Battery 20>

In general, the power saving function is employed at the battery drive as explained in FIG. 5. More specifically, a setting value of a high power saving effect is often used at the battery drive while a setting value of a low power saving effect is often used at the external power drive. For this reason, a phenomenon that the screen image on the external display suddenly disappears in the presentation often occurs at the battery drive. Therefore, the EC 116 may operate in the presentation mode under the conditions that the external display 40 is connected to the external display connection terminal and that the computer 10 is driven by the power from the battery 20.

Condition: <External Display 40 is Determined as Projector Based on EDID of External Display 40>

The projector 40A is often connected to the external display connection terminal as the external display, in the presentation, as explained with reference to FIG. 2. It can be determined, based on the EDID of the external display 40, whether the type of the external display 40 connected to the computer 10 corresponds to the projector 40A or not. For example, if information on the image size is not written in the EDID led from the external display 40 or if information of an aspect ratio is written in the EDID instead of the information on the image size, the type of the external display 40 can be determined to correspond to the projector 40A. Incidentally, the information on the image size is not information on resolution of the external display 40, but information on an actual size of the display screen of the external display 40.

The process of determining whether the external display 40 is the projector or not, based on the EDID, may be executed by the BIOS 150. The EC 116 receives a determination result from the BIOS 150. Then, the EC 116 may operate in the presentation mode under the conditions that the external display 40 is connected to the external display connection terminal and that the external display 40 is determined as the projector based on the EDID of the external display 40.

Alternatively, the EC 116 may receive the EDID of the external display 40 from the BIOS 150 and, further, determine whether the external display 40 is the projector or not, based on the EDID. Then, the EC 116 may operate in the presentation mode under the conditions that the external display 40 is connected to the external display connection terminal and that the external display 40 is determined as the projector based on the EDID of the external display 40.

Condition: <External Display 40 is Determined to have a Large Image Size, Based on EDID of External Display 40>

An external display having a large image size such as a large-screen TV is often connected to the computer 10, instead of a projector, in the presentation. The image size of the external display 40 connected to the computer 10 can be determined, based on the EDID of the external display 40. This determination processing may be executed by the BIOS 150. The EC 116 receives a determination result from the BIOS 150. Then, the EC 116 may operate in the presentation mode under the conditions that the external display 40 is connected to the external display connection terminal and that the external display 40 is determined to have a larger image size than a first image size based on the EDID of the external display 40. The first image size is a threshold image size, and the user can set or vary a value of the first image size by using BIOS setup. The BIOS 150 may hold a default value (initial value) of the threshold image size. In this case, as for the default value (initial value) of the threshold image size, the BIOS 150 may hold, for example, a 35-inch wide size, etc. as the threshold image size, in consideration of actual usability.

The EC 116 can be thereby allowed to operate in the presentation mode even in a case where presentation is executed by using a large-screen TV instead of a projector.

Alternatively, the EC 116 may receive the EDID (or the image size) of the external display 40 and the first image size from the BIOS 150 and, further, compare the image size of the external display 40 with the first image size and determine whether the external display 40 has a larger image size than the first image size or not. Then, the EC 116 may operate in the presentation mode under the conditions that the external display 40 is connected to the external display connection terminal and that the external display 40 is determined to have a larger image size than the first image size based on the EDID of the external display 40.

Condition: <Serial Number of External Display is Determined to Match Specific Serial Number (First Serial Number)>

A specific display monitor is often connected to the computer 10, instead of a projector or a large-screen TV, in the presentation. A serial number of the external display 40 is written in the EDID of the external display 40 connected to the computer 10. The BIOS 150 may determine whether the serial number of the external display 40 matches a specific serial number (first serial number) or not, based on the EDID of the external display 40, and may transmit the determination result to the EC 116. The user can preset the serial number of the display monitor to be employed for the presentation as the specific serial number (first serial number), by using the BIOS setup. The EC 116 receives a determination result from the BIOS 150. Then, the EC 116 may operate in the presentation mode under the conditions that the external display 40 is connected to the external display connection terminal and that the serial number of the external display 40 is determined to match the first serial number.

Alternatively, the EC 116 may receive the EDID (or the serial number) of the external display 40 and the first serial number from the BIOS 150 and, further, compare the serial number of the external display 40 with the first serial number. Then, the EC 116 may operate in the presentation mode under the conditions that the external display 40 is connected to the external display connection terminal and that the serial number of the external display 40 is determined to match the first serial number.

The first serial number is the serial number to permit the presentation mode, but a specific serial number to prohibit the presentation mode may be preset besides the first serial number, or instead of the first serial number.

In this case, if the serial number of the external display 40 is determined to match the specific serial number to prohibit the presentation mode, based on the EDID of the external display 40, the EC 116 does not operate in the presentation mode.

The user can preset the serial number of the display monitor which is not used for the presentation as the specific serial number to prohibit the presentation mode, by using the BIOS setup.

The presentation mode can be thereby prevented from operating in a case where the user works by using a multi-monitor environment on a desk.

Condition: <Ambient Brightness is Low>

The EC 116 may operate in the presentation mode under the conditions that the external display 40 is connected to the external display connection terminal and that ambient brightness detected by the illuminance sensor 33 is lower than first brightness. In general, presentation is often executed in a state in which illumination in a room is dark. Therefore, the EC 116 can be allowed to operate in the presentation mode in the only environment in which the presentation is executed, by adding the low ambient brightness to the presentation start conditions. It is assumed that, for example, after putting out illumination in a conference room and executing presentation (meeting) by using the computer 10 to which the projector is connected, the illumination is turned on and minutes of the meeting is prepared while the projector is connected to the computer 10. In this case, the presentation mode can be actuated during the presentation (meeting) along, and the power saving function can be actuated during work of preparing the meeting minutes.

The first brightness is threshold brightness, and the user can set a value of the first brightness by using the BIOS setup. Alternatively, the value of the first brightness may be predetermined. In this case, the user can determine whether the ambient brightness should be used as the presentation mode start condition or not by using the BIOS setup.

The processing of determining whether the detected ambient brightness is lower than the first brightness or not, may be executed by the BIOS 150. The EC 116 receives a determination result from the BIOS 150. The EC 116 may operate in the presentation mode under the conditions that the external display 40 is connected to the external display connection terminal and that the ambient brightness detected by the illuminance sensor 33 is lower than the first brightness.

Alternatively, the EC 116 may receive the detected ambient brightness and the first brightness from the BIOS 150 and, further, compare the detected ambient brightness with the first brightness. The EC 116 may operate in the presentation mode under the conditions that the external display 40 is connected to the external display connection terminal and that the ambient brightness detected by the illuminance sensor 33 is lower than the first brightness.

Condition: <AC Adaptor 119 is not Connected to Computer 10 and Computer 10 is driven by Power from Battery 20>

In a system for supporting the peak shift control, control of discharging from the battery 20 to drive the computer 10 by the battery 20 is executed even if the AC adaptor 119 is connected to the computer 10. As for the power saving function, however, in general, a setting value corresponding to the connection to the external power supply (AC adaptor 119) may be used in a state in which the AC adaptor 119 is connected to the computer 10.

For this reason, the EC 116 may operate in the presentation mode under the conditions that the external display 40 is connected to the external display connection terminal, that the AC adaptor 119 is not connected to the computer, and that the computer 10 is driven by the power from the battery 20.

The EC 116 does not operate in the presentation mode when the external display 40 is connected to the external display connection terminal, the AC adaptor 119 is connected to the computer, and the computer 10 is driven by the power from the battery 20.

Thus, the peak shift-controlled case can be covered by adding the conditions that the AC adaptor 119 is not connected to the computer and that the computer 10 is driven by the power from the battery 20, to the presentation start conditions.

The above-explained presentation start conditions are used to determine whether the current use situation based on the current use situation of the computer 10 is a situation in which the presentation is executed or not. Determining whether the current use situation is a situation in which the presentation is executed or not can be executed based on at least one of determinations as to (1) presence or absence of the external display, (2) whether the presentation key is pressed or not, (3) whether the computer is driven by the battery or not, (4) whether the external display is a projector or not, (5) the image size (screen size) of the external display is larger than the threshold size or not, (6) whether the external display has a specific serial number or not, and (7) the ambient brightness is low or not.

Alternatively, determining whether the current use situation is a situation in which the presentation is executed or not can be executed based on combination several specific conditions.

In this case, determining that the current use situation is a situation in which the presentation is executed may be executed when, for example, three conditions that (1) the computer is driven by the battery, (2) the EDID of the external display connected to the computer 10 is indicative of a projector, and (3) the ambient brightness obtained by the illuminance sensor 33 is low. The combination of the three conditions is one of effective combinations capable of automatically working the presentation mode in a suitable situation.

Next, several other characteristics of the presentation mode will be explained.

As explained above, the screen image of the external display can be prevented from suddenly disappearing by the EC 116 operating in the presentation mode. However, the power consumption of the computer 10 may be increased by the amount of prevention.

Thus, if the above-explained presentation start conditions are met, the EC 116 may operate in the presentation mode and execute a process for dimming or turning off the LCD 31. Increase in the power consumption of the computer 10 can be thereby suppressed without giving influence to the operation of presentation.

If the presentation mode is used, the time to allow the display to be turned on becomes long. This can be a factor which causes a risk on security that the information displayed on the screen may be seen by a third party at a high probability.

For this reason, use of the presentation mode may be permitted or prohibited by the BIOS setup. The EC 116 can operate in the presentation mode only when use of the presentation mode is permitted by the user or supervisor.

In other words, when use of the presentation mode is permitted by the BIOS 150, the EC 116 may operate in the presentation mode under the condition that the presentation start condition is met. In contrast, when use of the presentation mode is not permitted by the BIOS 150, the EC 116 does not operate in the presentation mode.

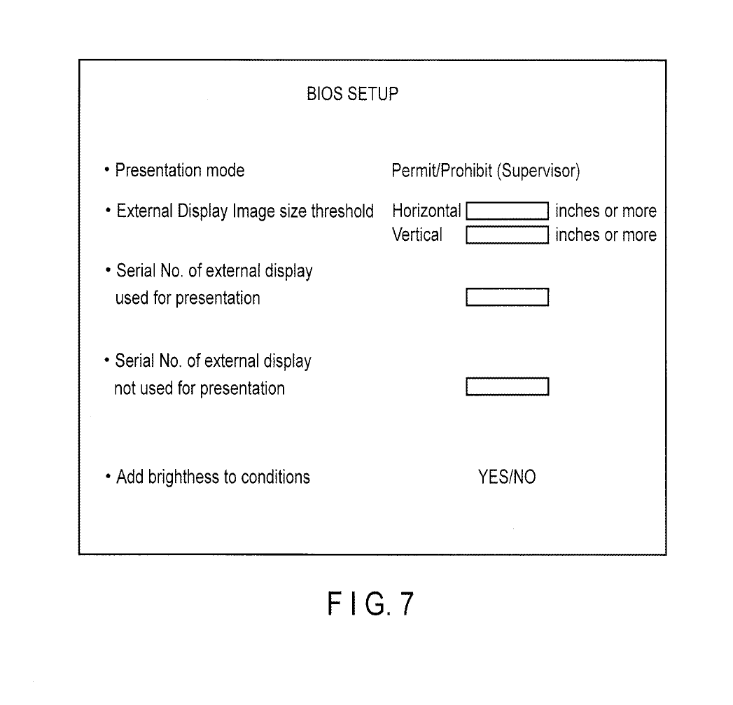

FIG. 7 illustrates an example of the BIOS setup screen.

A setting item to permit or prohibit the use of the presentation mode is displayed on the BIOS setup screen. The setting for permitting or prohibiting the use of the presentation mode may be permitted to the supervisor alone. In this case, the setting item to permit or prohibit the use of the presentation mode may be displayed on the BIOS setup screen only when a password matching the registered supervisor password is entered.

Furthermore, a setting item to set the image size threshold values (horizontal image size [inches] and vertical image size [inches]) of the external display is displayed on the BIOS setup screen.

Furthermore, a setting item to set the serial number of the external display used for the presentation and a setting item to set the serial number of the external display which is not used for the presentation are displayed on the BIOS setup screen.

Furthermore, a setting item to set the ambient brightness to be added or not to be added to the presentation start conditions is displayed on the BIOS setup screen.

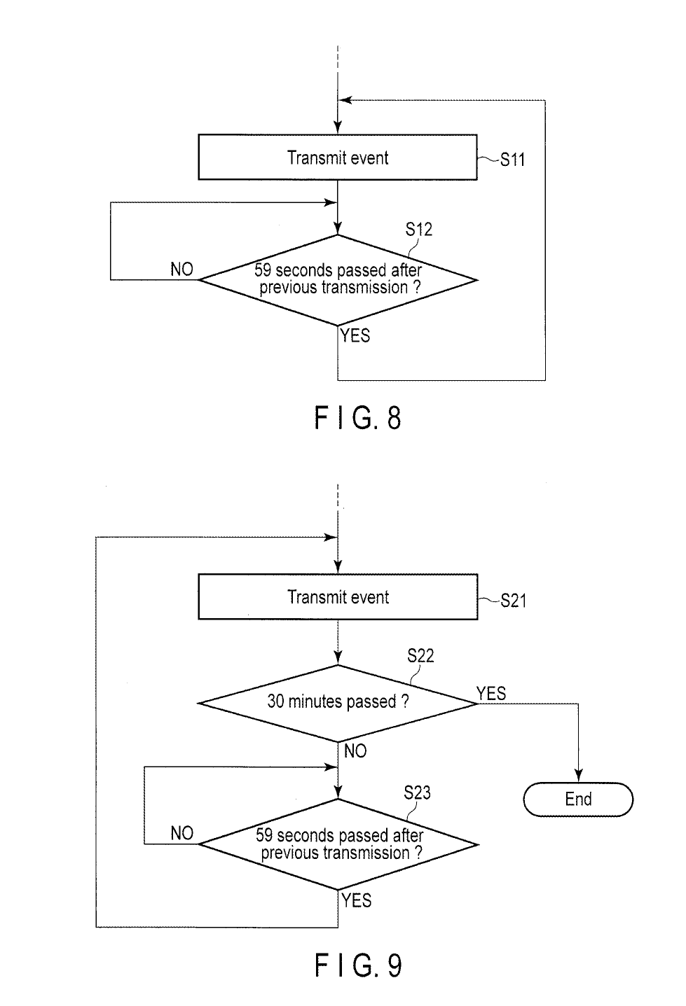

A flowchart of FIG. 8 shows a procedure of event transmission process executed by the EC 116.

The EC 116 may cyclically transmit the event to the processor 111 at a time interval shorter than a minimum time of the available setting time. If the minimum time of the available setting time is one minute, the EC 116 may cyclically transmit the event to the processor 111 at a time interval of, for example, 59 seconds. The number of times of transmitting the event can be thereby suppressed to the minimum required.

The EC 116 transmits the event to the processor 111 (step S11). Then, the EC 116 determines whether 59 seconds have passed after the previous event transmission or not (step S12). If 59 seconds have passed after the previous event transmission (YES in step S12), the EC 116 transmits the event to the processor 111 (step S11).

A flowchart of FIG. 9 shows a procedure of another event transmission process capable of automatically varying a setting time to transition to the power saving state to a certain long setting time.

The event transmission process is executed to extend the setting time indicating the time to transition to the power saving state, until the first time (for example, 30 minutes) has passed after start of the event transmission process, and the event transmission process is automatically ended after the first time has passed. The same advantage as that in the case of varying the setting time of the power saving function and extending the time to transition to the power saving state can be thereby obtained. The length of the first time may be predetermined or may be set or varied by the user.

The EC 116 transmits the event to the processor 111 (step S21). Then, the EC 116 determines whether the first time (for example, 30 minutes) has passed after start of the event transmission process or not (step S22).

If the first time (for example, 30 minutes) has not passed after start of the event transmission process (NO in step S22), the EC 116 determines whether 59 seconds have passed after the previous event transmission or not (step S23). If 59 seconds have passed since the previous event transmission (YES in step S23), the EC 116 transmits the event to the processor 111 (step S21).

The EC 116 determines whether the first time (for example, 30 minutes) has passed after start of the event transmission process or not, again (step S22). If the first time (for example, 30 minutes) has passed after start of the event transmission process (YES in step S22), the EC 116 ends the event transmission process.

By the processing in FIG. 9, the same advantage as that in the case of varying the setting value of the power saving function so as to extend the time to dim or turn off the display can be obtained, without actually varying the setting value of the power saving function. If the setting value of the power saving function is actually varied, restoring processing to return the setting value to the original value needs to be executed. Since the processing in FIG. 9 does not vary the setting value of the power saving function, the restoring procession is unnecessary.

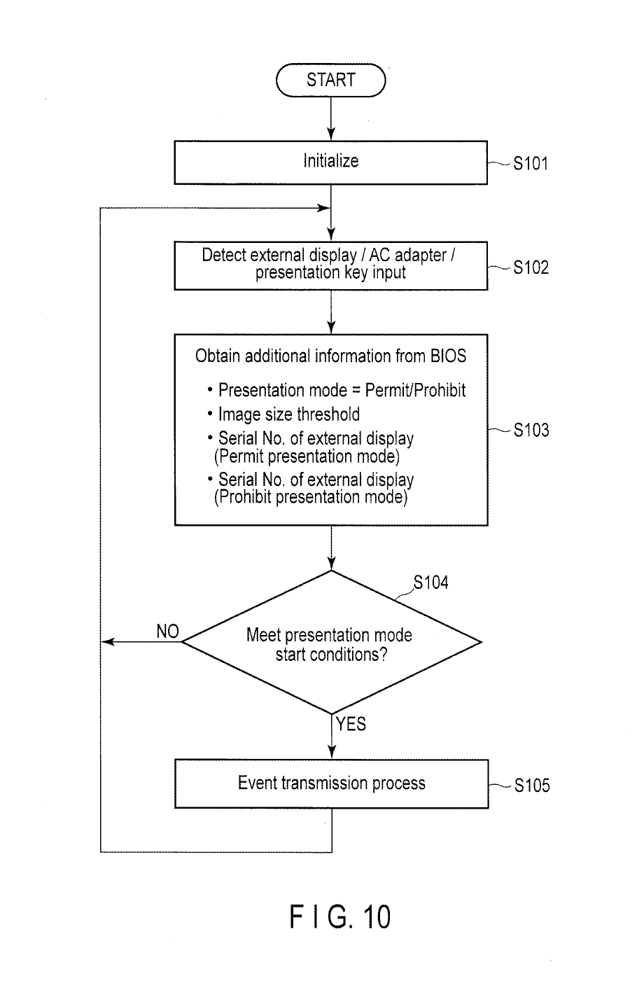

A flowchart of FIG. 10 shows a procedure of the operations executed by the EC 116.

The EC 116 first executes an initialization process (step 101). In step S101, the EC 116 may reset several inner register values in the EC 116, and set several inner register values to an initial value indicating that the external display 40 is not plugged, an initial value indicating that the AC adapter 119 is not plugged, and an initial value indicating that the presentation key is not pressed.

Then, the EC 116 determines whether the external display 40 is plugged or unplugged, whether the AC adapter 119 is plugged or unplugged, and the presentation key has been pressed or not (step S102). After that, the EC 116 obtains the additional information from the BIOS 150 by communicating with the BIOS 150 (step S103). In step S103, the EC 116 receives the setting value indicating whether the presentation mode is permitted or prohibited, from the BIOS 150.

Furthermore, the EC 116 may receive from the BIOS 150 (1) a setting value indicating the image size threshold value, (2) a setting value indicating the serial number (first serial number) of the external display in which use of the presentation mode should be permitted, (3) a setting value indicating the serial number (second serial number) of the external display in which use of the presentation mode should be prohibited, (4) a setting value as to whether the brightness should be added to the presentation mode start conditions or not, etc.

The EC 116 may also receive the EDID read from the external display connected to the computer 10, the detection value of the illuminance sensor 33, etc. from the BIOS 150.

The EC 116 can determine by itself whether the presentation mode start conditions are met or not, based on the additional information received from the BIOS 150.

Alternatively, the EC 116 may receive several determination results from the BIOS 150 as additional information. The determination results may include (1) the determination result as to whether the external display connected to the computer 10 is a projector or not, (2) the determination result as to whether the image size of the external display connected to the computer 10 is larger than the image size threshold value or not, (3) the determination result as to whether the serial number of the external display matches the first serial number or not, (4) the determination result as to whether the ambient brightness detected by the illuminance sensor is lower than the first brightness or not, etc.

The EC 116 determines whether the presentation mode start condition is met or not, based on the state which the EC 116 detects by itself and the additional information (determination results) received from the BIOS 150 (step S104).

If the presentation mode start condition is not met (YES in step S104), the EC 116 executes the event transmission process explained in FIG. 8 or the event transmission process explained in FIG. 9 (step S105).

In contrast, if the presentation mode start condition is not met (NO in step S104), the EC 116 does not execute the event transmission process.

The EC 116 monitors a current environment of the computer 10 by repeating the processing in steps S102 to S104. Therefore, the event transmission process is executed in the only period in which the presentation mode start conditions are met.

Incidentally, if the EC 116 receives from the BIOS 150 the information indicating that the presentation mode is prohibited, the EC 116 may determine that the presentation mode start conditions are not met irrespective of whether other conditions relating the presentation mode start conditions are met or not. The execution of the event transmission process is therefore prohibited.

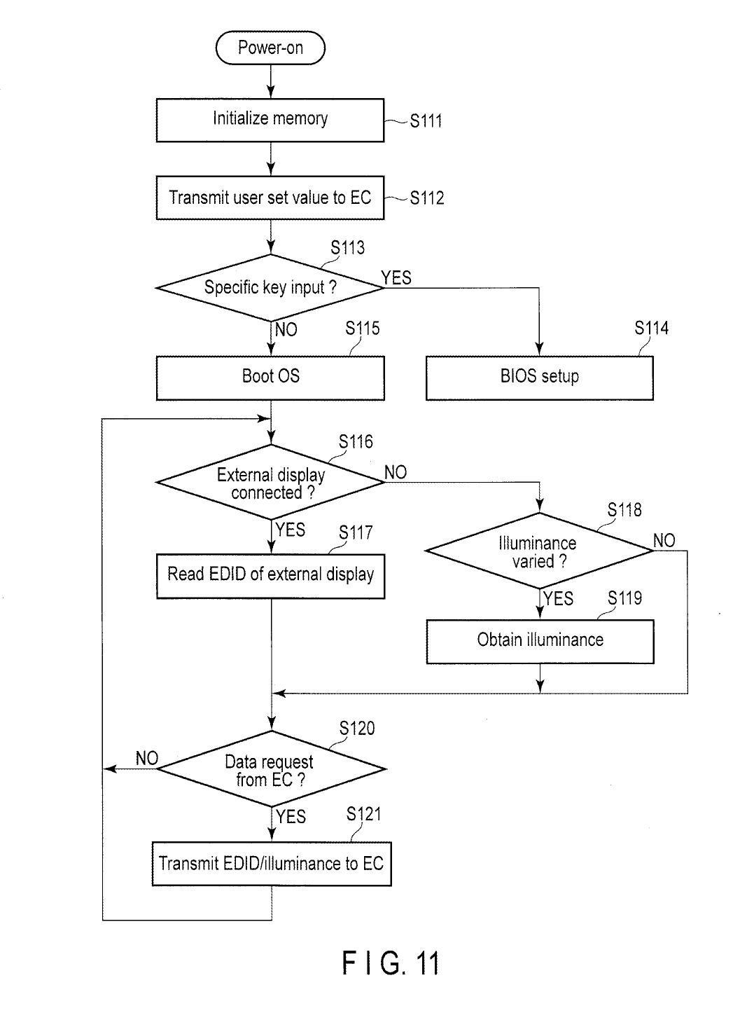

A flowchart of FIG. 11 shows a procedure of the operations executed by the BIOS 150.

When the computer 10 is powered on, the BIOS 150 initializes the memory in the computer 10 including the main memory 113 (step S111). Then, the BIOS 150 transmits to the EC 116 several setting values that have been set by the BIOS setup by the user (step S112). The setting values include (1) the setting value indicating whether the presentation mode is permitted or prohibited, (2) the setting value indicating the serial number of the external display in which use of the presentation mode should be permitted, (3) the setting value indicating the serial number of the external display in which use of the presentation mode should be prohibited, and (4) the setting value as to whether the brightness should be added to the presentation mode start conditions or not. A default value (initial value) of the setting value indicating whether the presentation mode is permitted or prohibited may indicate prohibition of the presentation mode.

The BOIS 150 executes a process of displaying a logo of a vender of the computer 10 on the screen, and determines whether a specific key to call the BIOS setup process has been pressed by the user or not, during the display of the logo (step S113).

If the specific key has been pressed by the user (YES in step S113), the BIOS 150 starts the BIOS setup process and displays the BIOS setup screen explained with reference to FIG. 7. The user can set or vary the values concerning various setting items on the BIOS setup screen.

If the specific key has not been pressed by the user during the display of the logo (NO in step S113), the BIOS 150 boots the operating system (OS) (step S115).

After the OS has been booted, the BIOS 150 is called by interruption processing when specific events such as plugging and unplugging of the external display and the variation in brightness occur, or when events such as reception of the request from the EC occur.

For example, the BIOS 150 determines whether an event of a hot plug indicating that the external display is connected to the external display connection terminal (HDMI output terminal 23 or RGB port 24) of the computer 10 has occurred or not (step S116).

If the event of the hot plug has occurred, i.e., if the external display is connected to the external display connection terminal of the computer 10 (YES in step S116), the BIOS 150 reads the EDID of the external display (step S117).

In contrast, if the event concerning the variation in brightness has occurred (YES in step S118), the BIOS 150 obtains from the illuminance sensor 33 the current brightness value detected by the illuminance sensor 33 (step S119).

The BIOS 150 awaits data request from the EC 116 (step S120). If the data request from the EC 116 is received (YES in step S120), the BIOS 150 transmits the EDID, the current brightness value, etc. to the EC 116 (step S121).

In step S121, the BIOS 150 may not transmit the EDID to the BIOS 150, but transmit to the EC 116 several determination results indicating whether each of several conditions concerning the external display and the current brightness value as explained above is met or not.

According to the present embodiment, as explained above, the EC 116 automatically executes the process of cyclically transmitting the event capable of clearing the timer 2000A to the processor 111, when the presentation start condition is met. Thus, occurrence of the phenomenon that the screen image on the external display suddenly disappears while the presentation is executed by the user can be suppressed.

Each of various functions described in the embodiment may be implemented by circuitry (processing circuitry). Examples of the processing circuitry include a programmed processor such as a central processing unit (CPU). The processor executes each of the described functions by executing the computer program (instructions) stored in the memory. The processor may be a microprocessor comprising an electric circuit. Examples of the processing circuit include a digital signal processor (DSP), application specific IC (ASIC), a microcomputer, a controller, other electric circuit components, etc. Each of the components other than CPU described in the embodiments may also be implemented by processing circuitry.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
an internal display;
a display controller configured to supply a display signal to the internal display and an external display connected to an external display connection terminal;
a processor configured to execute a process of setting the apparatus to be in a power saving state in which the internal display is dimmed or turned off and supply of the display signal to the external display is stopped, when a time elapsed after input data is last received from an input device reaches a setting time, wherein the elapsed time is measured by using a timer; and
a system controller configured to execute a process of cyclically transmitting an event capable of clearing the timer to the processor, under a condition that the external display is connected to the external display connection terminal.

2. The apparatus of claim 1, wherein
the system controller is configured to execute the process of cyclically transmitting the event to the processor, under conditions that the external display is connected to the external display connection terminal and that a key operation for validating a presentation mode capable of suppressing setting the apparatus to be in the power saving state is executed.

3. The apparatus of claim 1, wherein
the system controller is configured to execute the process of cyclically transmitting the event to the processor, under conditions that the external display is connected to the external display connection terminal and that the apparatus is driven by electric power from a battery in the apparatus.

4. The apparatus of claim 1, wherein
the system controller is configured to execute the process of cyclically transmitting the event to the processor, under conditions that the external display is connected to the external display connection terminal and that the external display is determined to be a projector, based on identification information of the external display.

5. The apparatus of claim 1, wherein
the system controller is configured to execute the process of cyclically transmitting the event to the processor, under conditions that the external display is connected to the external display connection terminal and that ambient brightness detected by an illuminance sensor is lower than first illuminance.

6. The apparatus of claim 1, wherein
the system controller is configured to execute the process of cyclically transmitting the event to the processor, under conditions that the external display is connected to the external display connection terminal and that the external display is determined to have an image size larger than a first image size, based on identification information of the external display.

7. The apparatus of claim 6, wherein
the first image size is set at a value designated by the user.

8. The apparatus of claim 1, wherein
the system controller is configured to execute the process of cyclically transmitting the event to the processor, under conditions that the external display is connected to the external display connection terminal and that a serial number of the external display is determined to match a serial number which should permit the process of cyclically transmitting the event to the processor to be executed based on identification information of the external display.

9. The apparatus of claim 1, wherein
the system controller is configured to not execute the process of cyclically transmitting the event to the processor, when a serial number of the external display is determined to match a serial number which should prohibit the process of cyclically transmitting the event to the processor to be executed based on identification information of the external display.

10. The apparatus of claim 1, wherein
the system controller is configured to execute the process of cyclically transmitting the event to the processor, under conditions that the external display is connected to the external display connection terminal, that an external power supply is not connected to the apparatus, and that the apparatus is driven by electric power from a battery in the apparatus, and
the system controller is configured to not execute the process of cyclically transmitting the event to the processor, when the external display is connected to the external display connection terminal, the external power supply is connected to the apparatus, and the apparatus is driven by the electric power from the battery.

11. The apparatus of claim 1, wherein
the system controller is configured to execute the process of cyclically transmitting the event to the processor and a process of dimming or turning off the internal display, under the condition that the external display is connected to the external display connection terminal.

12. The apparatus of claim 1, wherein
the system controller is configured to execute the process of cyclically transmitting the event to the processor, under the condition that the external display is connected to the external display connection terminal, when use of a presentation mode capable of suppressing setting the apparatus to be in a power saving state is permitted by a Basic Input/Output System (BIOS), and
the system controller is configured to not execute the process of cyclically transmitting the event to the processor, when the use of the presentation mode is not permitted by the Basic Input/Output System (BIOS).

13. The apparatus of claim 1, wherein
the process of cyclically transmitting the event to the processor is executed to extend the setting time to a first time until the first time has elapsed after start of the processing, and the process is ended after the first time has elapsed.

14. The apparatus of claim 1, wherein
the system controller is configured to execute a process of cyclically transmitting a set of commands to the processor as the event, the set of commands comprising a command to move cursor coordinates of a pointing device by at least one pixel and a command to return the cursor coordinates to original position.

15. The apparatus of claim 1, wherein
the event includes a notify command to notify an operating system that a device is detected.

16. The apparatus of claim 1, wherein
the system controller is configured to cyclically transmit the event at a time interval shorter than a minimum time of an available setting time.

17. The apparatus of claim 1, wherein
the system controller is configured to execute the process of cyclically transmitting the event to the processor, under conditions that the external display is connected to the external display connection terminal, that the apparatus is driven by electric power from a battery in the apparatus, that the external display is determined to be a projector, based on identification information of the external display, and that ambient brightness detected by an illuminance sensor is lower than first brightness.

18. A method comprising:
supplying a display signal to an internal display of an information processing apparatus and an external display connected to an external display connection terminal of the information processing apparatus;
setting the information processing apparatus to be in a power saving state in which the internal display is dimmed or turned off and supply of the display signal to the external display is stopped, when a time elapsed after input data is last received from an input device reaches a setting time, wherein the elapsed time is measured by using a timer; and
cyclically transmitting an event capable of clearing the timer to a processor in the information processing apparatus, under a condition that the external display is connected to the external display connection terminal.
